(19) United States
(12) Patent Application Publication
(10) Pub. No.: US 2010/0129769 A1
(43) Pub. Date: May 27, 2010

(54) Dental Delivery System

(76) Inventor: Nilton Albano Junge, Santa Catarina (BR)

Correspondence Address: Timothy H. Van Dyke;Beusse Wolter Sanks Mora & Maire, P.A., Suite 2500, 390 North Orange Avenue, Orlando, FL, 32801, US

(21) Appl. No.: 12/404,382

(22) Filed: Mar. 16, 2009

Related U.S. Application Data
(60) Provisional application No. 61/117,210, filed on Nov. 23, 2008.

(51) Int. Cl. A61C 3/00

(52) U.S. Cl. 433/77

(57) ABSTRACT

Disclosed herein is a dental delivery unit designed for handling one or several dental whips. Specifically exemplified herein is a dental delivery unit that includes a whip base, a whip arm that moves respective to the whip base and a locking mechanism that releasably locks the whip arm in a predetermined position. The locking whip arm allows for an extension of the a dental whip and use of a dental whip that avoids a constant retractive force while the dental whip is in use.

### RELATED APPLICATIONS

This application claims priority to U.S. Ser. No. 61/117,210 filed Nov. 23, 2008, which is incorporated herein in its entirety.

### FIELD OF THE INVENTION

This invention relates to dental delivery systems that house and deliver operating utilities to dental tools. More particularly this invention relates to dental delivery systems employing a whip arm to secure the flexible utility conduit attached to the dental tool.

### BACKGROUND

Dental procedures often require dental personnel to employ dental tools that require utility connections to a base unit, generally known as a dental delivery system base unit. The dental delivery system base is often the source for utilities required to operate the tools, such as, but not limited to rinsing water, compressed air, computer and video network cabling, and electricity etc. The utilities are usually delivered from the dental delivery system base unit to the dental tool via flexible conduits, such as plastic tubing, hoses, or cords etc. However, the distance between the dental delivery system base unit and the patient's mouth can require the flexible utility conduits to be several feet in length, and these lengths can interfere with dental procedures.

Several systems of managing these lengths of flexible utility conduits have been devised. These systems usually store the unused portion of the flexible utility conduits either suspended in an area by the dental delivery system base, or on a spring coiled spool, which takes up unused portions of spool as the unused length adjusts during a procedure. One particular system that has been devised is known in the art as the “whip arm.” A whip arm is a mechanism in which an arm, usually located on the far side of a dental delivery system, is pivoted where it is connected to a base. A flexible utility conduit is run from the dental delivery system, away from the patient and through the whip arm, and then toward the patient, where it attaches to a dental tool and rests in a cradle, which is part of the dental delivery system base. The whip arm is usually lightly spring loaded to remain in its retracted position. When dental personnel pull on the dental tool, and associated flexible utility conduit, the force in the flexible utility conduit moves the whip from its retracted position, thus allowing the flexible utility conduit to travel with the dental tool, providing slack so the dental tool can be used. In such systems, constant tension remains on the flexible utility conduit, and dental tool, throughout the procedure.

### BRIEF DESCRIPTION OF THE DRAWINGS

The invention is explained in the following description in view of the drawings that show:

FIG. 1 is a perspective view of a dental delivery unit with multiple whip arms.

FIG. 2 is a side view of a whip arm and whip arm base in the fully retracted position.

FIG. 3 is a side view of a whip arm and whip arm base as the whip arm begins to move from the fully retracted position.

FIG. 4 is a side view an extending whip arm and whip arm base as the latch plate begins to yield to the locking pin.

FIG. 5 is a side view of a whip arm and whip arm base in the operating position, where the latch plate has engaged the locking pin.

FIG. 6 is a side view of a whip arm and base of FIG. 5, where the locking pin has moved to the releasing position of the latch plate.

FIG. 7 is a side view of a retracting whip arm and base of FIG. 6 where the locking pin is disposed under the latch plate.

FIG. 8 is a side view of a retracting whip arm and base of FIG. 7 where the whip arm has retracted enough to move the locking pin from under the latch plate.

FIG. 9 is a perspective view of a latch plate.

### DETAILED DESCRIPTION

The present inventors have recognized that the constant tension on the flexible utility conduit and dental tool can be an annoyance as well as a source of fatigue in the hands of dental personnel, which could lead to less efficient dental procedures. The present inventors have invented an innovative locking mechanism for use with a whip arm that, with minimal effort, will lock the whip arm in an operating position. This inventive locking mechanism will eliminate tension in the flexible utility conduit and dental tool arising from the whip arm spring. This, in turn, will reduce annoyance and possibly increase the efficiency of the dental procedures. Also, with minimal further effort, the present invention will retract the flexible utility conduit and tool once the user is finished. Thus, the locking mechanism of the present invention retains the advantages of the prior whip arm systems while providing these new benefits. Further, the locking mechanism of the present invention accomplishes this using very few parts, which are simple and inexpensive to manufacture, and easy to install and replace.

In one embodiment, the invention pertains to a dental delivery unit that provides at least one dental whip. The dental delivery unit includes a whip arm base and a whip arm connected to the whip arm base such that the whip arm retracts and extends relative to the whip base. The whip arm is resiliently biased toward a retracted position. The dental delivery unit also includes a locking mechanism associated with the whip base and whip arm, wherein the locking mechanism releasably locks the whip arm in an operating position.

In another embodiment, the invention is directed to a whip arm assembly that includes a whip arm, a whip arm base, and a locking mechanism that locks the whip arm in a position relative to the whip arm base. The whip arm arm is rotatably attached to the whip arm base and resiliently maintained in a first position. The locking mechanism is responsive to a first predetermined amount of rotation of the whip arm arm from the first position.

In yet another embodiment, the invention is directed to a lock mechanism for a whip arm assembly comprising a whip arm and a whip arm base, where the lock mechanism comprises a locking pin and a latch plate. The locking pin moves circumferentially toward the latch plate as the whip arm extends. The latch plate rests in a disengaged position and has an edge structured to cause the resiliently biased latch to yield to the locking pin as the locking pin moves circumferentially. The latch plate also includes a locking recess adjacent to the edge configured to allow the locking plate to move partway back toward the disengaged position, in accord with its bias, to a locking position once the locking pin travels past the edge, thereby engaging the locking pin.

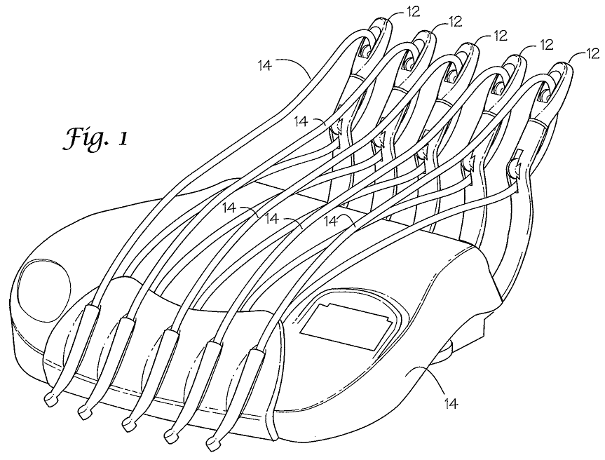

Turning to the drawings, FIG. 1 shows a perspective view of a dental distribution unit 10 with multiple whip arms 12 that are supporting dental whips 14.

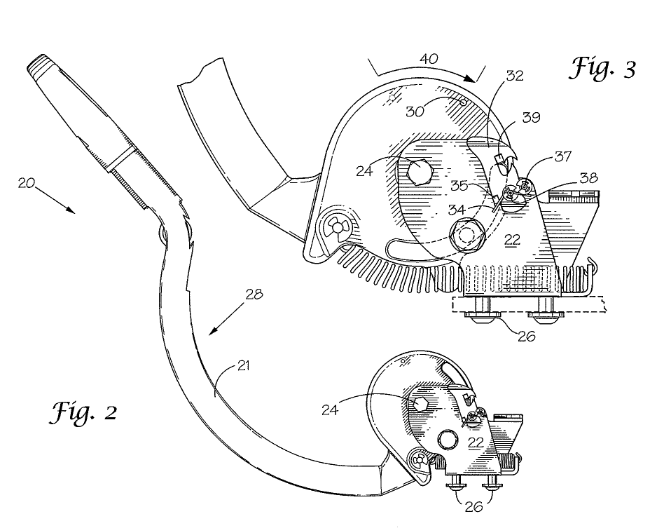

FIGS. 2 and 3 show what is shown is a whip arm assembly (20), a whip arm (21), a whip arm base (22), and an axis (24) about which the whip arm (21) can rotate. A spring (not shown) holds the whip arm (21) in the retracted position (28) as shown. The whip arm base can be mounted to a dental delivery unit (not shown) using mounting bolts (26) or any other means.

FIG. 3 shows lock pin (30) attached to the whip arm (21), where the whip arm (21) is positioned slightly out of the retracted position (28). Latch plate (32) is attached to the whip arm base (22). Latch plate (32) pivots about latch plate pin (38). Around latch plate pin (38) is torsion spring (34), which presses on latch plate (32) at torsion spring catch (35), and on base pin (37). This biases latch plate (32) away from pivot axis (24). Latch plate (32) further contains ramp (39).

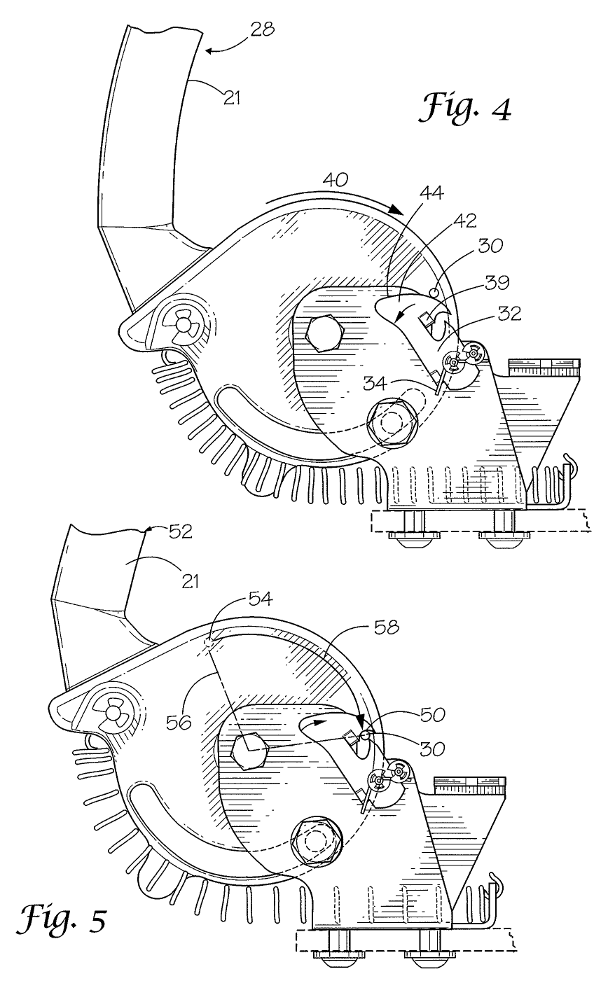

FIG. 4 shows whip arm (21) moving in direction (40) of rotation from the retracted position (28) toward an extended position. Latch plate (32) has latch plate edge (44) and locking pin (30) rides along latch plate edge (44), pushing the latch plate radially inward against its bias in direction (42) as whip arm (28) extends.

FIG. 5 shows whip arm (21) once it has reached the operating position (52). Element (54) depicts the position of locking pin (30) when whip arm (21) is in the retracted position (28). Arrow (58) shows the circumferential path of travel that locking pin (30) takes as whip arm (21) extends from a retracted position (28) to the operating position (52). Upon sufficient extension of whip arm (21), latch plate (32) moves radially away from axis (24) to engage locking pin (30) in the locked position (50) of latch plate (32), thus locking the whip arm (21) in the operating position (52). Angle (56) shows a first amount of angular travel that locking pin (30) must cover in order for latch plate (32) to engage locking pin (30).

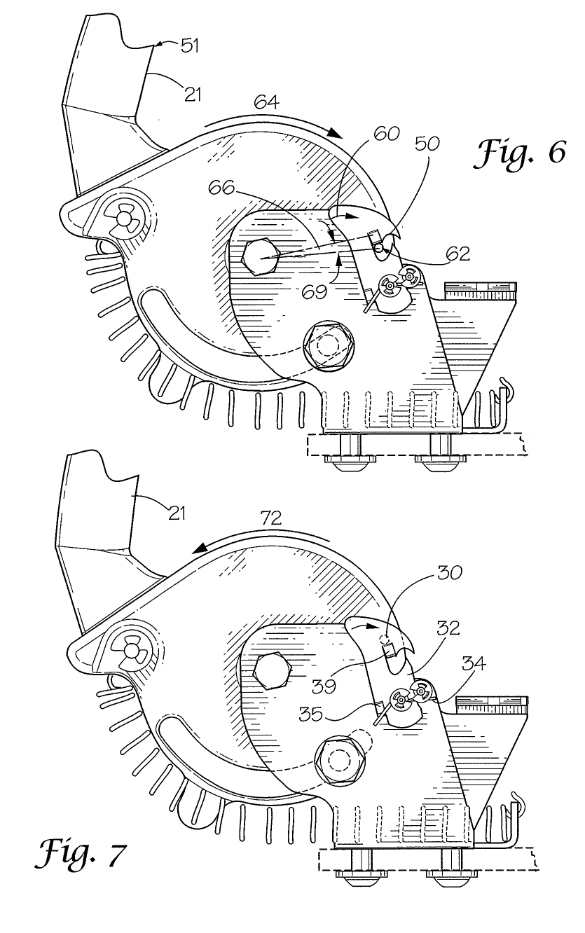

As shown in FIG. 6, whip arm (21) is subsequently rotated to an extended position (62). This rotation is shown by arrow (64). During this rotation locking pin (30) is rotated from position (50) to position (62). Angle (66) shows the angular distance that locking pin (30) must travel in order for latch plate (32) to be free to move radially away from axis (24) such that locking pin (30) enters the releasing position (62) of latch plate (30). The latch plate's (30) motion during this time is shown by arrow (60). Arrow (69) indicates the subsequent circumferential travel of pin (30), which allows latch plate (32) to move in direction (60).

FIG. 7 shows whip arm (21) as it rotates as shown by arrow (72) towards it retracted position, during which locking pin (30) engages ramp (39). Latch plate (32) is also held in place against whip arm (21) by torsion spring (34). This role is in addition to torsion spring's (34) role of biasing latch plate (32) radially outward from axis (24). As locking pin (30) moves circumferentially as whip arm (21) rotates back toward the retracted position, locking pin (30) pushes latch plate (32) up as locking pin (30) moves under ramp (39), resulting in latch plate (32) riding over locking pin (30), freeing whip arm (21) to return to the retracted position as locking pin (30) rotates out from under latch plate (32). Latch plate (32) returns to its position against whip arm (21) through the force applied by torsion spring (34).

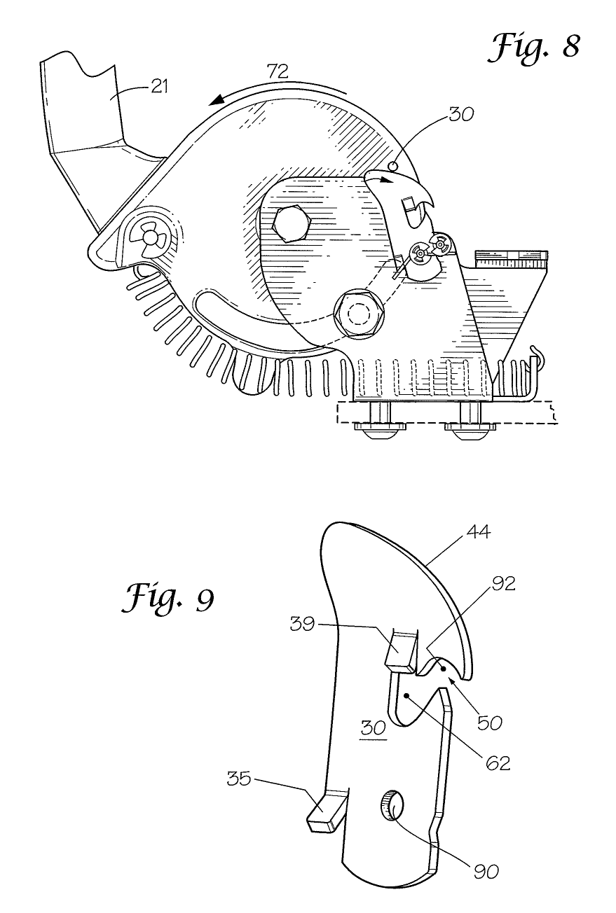

FIG. 8 shows the whip arm (21) of FIG. 8 retracted slightly further than in FIG. 8 such that locking pin (30) is clear of latch plate (32). Latch plate (32) has returned to its position of rest against whip arm (21), and whip arm (21) is free to return to the fully retracted position (28).

FIG. 9 shows a diagrammatic representation of latch plate (30), latch plate edge (44), ramp (39), torsion spring catch (35), opening (90) for the latch plate pin (38) (not shown), locking recess (92), and locking position (50) for locking pin (30) (not shown) and releasing position (62) for locking pin (30).

Thus, it can be understood that the inventors of the locking mechanism have invented an innovative, simple, and inexpensive device that may alleviate fatigue in the hands of dental personnel, and possibly result in more efficient dental procedures.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A dental delivery unit for handling one or more dental whips, the dental delivery unit comprising:
a whip arm base,
a whip arm connected to the whip arm base such that the whip arm retracts and extends relative to the whip base, wherein the whip arm is resiliently biased toward a retracted position, and
a locking mechanism associated with the whip base and whip arm, wherein the locking mechanism releasably locks the whip arm in an operating position.

2. The dental delivery unit of claim 1, wherein the whip arm is rotatably attached to the whip arm base at a pivot point, and the whip arm rotates about the pivot point when the whip arm is extended, and wherein the locking mechanism holds the whip arm in the operating position once the whip arm rotates a first predetermined amount, and the locking mechanism releases the whip arm from the operating position once the whip arm subsequently rotates a second predetermined amount.

3. The dental delivery unit of claim 2, wherein the locking mechanism further comprises a lock pin attached to the whip arm, and further comprises a latch attached to the whip arm base that is constructed and arranged to engage the locking pin when the whip arm rotates the first predetermined amount, and to disengage the locking pin when the whip arm subsequently rotates the second predetermined amount.

4. The dental delivery unit of claim 3, wherein the latch is resiliently biased radially away from the pivot point and yields radially inward to the locking pin once the locking pin contacts the latch as the locking pin circumferential travels around the pivot point during rotation of the whip arm, and wherein, and once the whip arm rotates the first predetermined amount the latch is constructed and arranged to move radially outward from the pivot point to engage the locking pin and hold the whip arm in the operating position.

5. The dental delivery unit of claim 4, wherein, upon a subsequent circumferential travel of the locking pin during rotation of the whip arm the second predetermined amount, the latch is further configured to move further radially outward from the pivot point and to disengage the locking pin, thereby releasing the whip arm.

6. A whip arm assembly comprising a whip arm, a whip arm base, and a locking mechanism that locks the whip arm in a position relative to the whip arm base, wherein the whip arm arm is rotatably attached to the whip arm base and resiliently maintained in a first position, and wherein the locking mechanism is responsive to a first predetermined amount of rotation of the whip arm arm from the first position.

7. The whip arm assembly of claim 6, wherein the locking mechanism further comprises a locking pin attached to the whip arm, and a latch rotatably attached to the whip arm base, wherein the latch is resiliently biased toward a disengaged position, and wherein the latch is moved from the disengaged position by the locking pin when the whip arm is rotated from the first position, and wherein the latch begins to return to the disengaged position when the whip arm rotates the first predetermined amount, the latch thereby engaging the locking pin and preventing the whip arm from returning to the first position.

8. The whip arm assembly of claim 7, wherein the latch moves closer to the disengaged position upon a subsequent, further rotation of the whip arm a second predetermined amount, and thereby disengages the pocking pin, freeing the whip arm to return to the first position.

9. A dental delivery unit comprising the whip arm of claim 6.

10. A dental delivery unit comprising the whip arm of claim 8.

11. A lock mechanism for a whip arm assembly comprising a whip arm and a whip arm base, where the lock mechanism comprises a locking pin and a latch plate, wherein the locking pin moves circumferentially toward the latch plate as the whip arm extends, and wherein the latch plate rests in a disengaged position and comprises an edge structured to cause the resiliently biased latch to yield to the locking pin as the locking pin moves circumferentially, and wherein the latch plate further comprises a locking recess adjacent to the edge configured to allow the locking plate to move partway back toward the disengaged position, in accord with its bias, to a locking position once the locking pin travels past the edge, thereby engaging the locking pin.

12. The lock mechanism of claim 11, wherein the latch plate is configured to move from the locking position to a releasing position, in accord with its bias, upon a subsequent circumferential movement of the locking pin, and wherein the latch plate is further resiliently biased to remain in a plane and further comprises a ramp configured to change the plane of the latch plate as the locking pin moves along the ramp while the locking pin moves circumferentially, thereby moving the latch plate over the locking pin, freeing the locking pin.

13. A whip arm comprising the locking mechanism of claim 12.

14. A dental delivery unit comprising the whip arm of claim 13.
